(19) United States
(12) Patent Application Publication
(10) Pub. No.: US 2026/0187873 A1
(43) Pub. Date: Jul. 2, 2026

(54) Electronic Devices and Corresponding Methods for Identifying Parties in Screenshot Communications

(71) Applicant: Motorola Mobility LLC, Chicago, IL (US)

(72) Inventors: Amit Kumar Agrawal, Bangalore (IN); Krishnan Raghavan, Bangalore (IN)

(21) Appl. No.: 19/005,919

(22) Filed: Dec. 30, 2024

(51) Int. Cl. G06T 11/60; G06F 40/169; H04L 51/10

(52) U.S. Cl. CPC G06T 11/60; G06F 40/169; H04L 51/10

(57) ABSTRACT

A method in an electronic device involves receiving user input requesting the transmission of a screenshot of communication dialogue to a remote electronic device. The method includes extracting identifiers of parties represented by pronouns in the communication dialogue using one or more processors. The processors then modify the screenshot so that the pronouns identify the parties represented by them. The modification can include overlays, replacing pronouns with names, reversing geometric alignment, changing colors, or reversing pronouns. The method may also involve determining whether the communication dialogue is a one-to-one or group conversation and whether the remote device belongs to a third party. The system ensures clarity by annotating the screenshot before transmission, enhancing communication and reducing misunderstandings.

### BACKGROUND

### Technical Field

This disclosure relates generally to electronic devices having displays, and more particularly to electronic devices capable of capturing images of content presented on a corresponding display.

### Background Art

The practice of sharing screenshots of conversations has become increasingly common in digital communication. Individuals often share these screenshots for various reasons, such as seeking advice or opinions, providing documentation or evidence, sharing noteworthy moments, clarifying misunderstandings, passing on information, serving as reminders or references, maintaining records, expressing concerns, or for entertainment and amusement. The act of sharing screenshots can lead to ambiguity and potential confusion for other parties involved. It would be advantageous to have improved electronic devices and corresponding methods alleviating these issues.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory method and corresponding system in accordance with one or more embodiments of the disclosure.

FIG. 3 illustrates another explanatory method in accordance with one or more embodiments of the disclosure.

FIG. 4 illustrates one or more method steps in accordance with one or more embodiments of the disclosure.

FIG. 5 illustrates an explanatory system in accordance with one or more embodiments of the disclosure.

FIG. 6 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to receiving, at a user interface, user input requesting a communication device of the electronic device transmit a screenshot of communication dialogue to a remote electronic device, extracting, by one or more processors, from application data of an application from which the screenshot was taken, identifiers of parties represented by pronouns in the communication dialogue, and modifying, by the one or more processors prior to transmission by the communication device, the screenshot so that the pronouns in the communication dialogue identify the parties represented by the pronouns in the communication dialogue. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors of an electronic device to, in response to the user interface receiving user input capturing a screenshot of a communication dialogue, identify parties engaged in the communication dialogue represented by pronouns in the communication dialogue from a contact database accessible to the one or more processors, and modify the screenshot to cause the parties identified by the pronouns to be identified by name as described herein. The non-processor circuits may include, but are not limited to, a radio receiver, a radio transmitter, signal drivers, clock circuits, power source circuits, and user input devices.

As such, these functions may be interpreted as steps of a method to perform detecting, by one or more processors, capture of a screenshot depicting communication dialogue, extracting, by the one or more processors, identifiers of persons represented by at least some words depicted in the communication dialogue, annotating, by the one or more processors, the at least some words with the identifiers of the persons to create an annotated screenshot, and causing, by the one or more processors, a communication device to transmit the annotated screenshot to a remote electronic device across a network. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, the practice of sharing screenshots of private conversations has become increasingly common in digital communication. Individuals often share these screenshots for various reasons, such as seeking advice or opinions, providing documentation or evidence, sharing noteworthy moments, clarifying misunderstandings, passing on information, serving as reminders or references, maintaining records, expressing concerns, or for entertainment and amusement. This widespread practice reflects the multifaceted nature of digital communications, and the social dynamics involved.

As also noted above, the act of sharing screenshots can lead to ambiguity and potential confusion for other parties involved. Embodiments of the disclosure contemplate that labeling problems in screenshots can arise due to the use of ambiguous or unclear identifiers. Specifically, the use of pronouns such as “you” within the conversation context can be unclear when viewed by someone not involved in the conversation. This makes discerning who the pronouns refer to challenging, causing confusion.

Additionally, without clear labels or identifiers for each participant, viewers may struggle to distinguish who said what, especially in one-on-one chats or group conversations. This labeling issue creates confusion and makes understanding the roles and identities of the participants difficult for individuals outside the conversation, potentially leading to misunderstandings or misinterpretations of the conversation's content.

Advantageously, embodiments of the disclosure address these issues by providing relational affordance on shared screenshots for communication dialogues. In one or more embodiments, a method in an electronic device involves detecting the capture of a screenshot of a communication dialogue on an electronic device. In one or more embodiments, optionally using artificial intelligence-based screenshot techniques, the system extracts the information from the screenshot and determines whether the communication dialogue belongs to a one-to-one conversation or a group conversation.

In one or more embodiments, the system then extracts and stores the exact sender information of each message in the communication dialogue as metadata. When the screenshot is shared with a third contact who is not part of the original communication dialogue, the system annotates the sender information associated with each dialogue in the screenshot in one or more embodiments. This annotation process may include modifying the annotations depending on the recipient of the screenshot, such as adding the name of a person instead of “you” to messages.

Illustrating by example, in one or more embodiments a method in an electronic device involves receiving, at a user interface, user input requesting a communication device of the electronic device to transmit a screenshot of a communication dialogue to a remote electronic device. In one or more embodiments, the method includes extracting, by one or more processors, from application data of an application from which the screenshot was taken, identifiers of parties represented by pronouns in the communication dialogue. In one or more embodiments, the method further comprises modifying, by the one or more processors prior to transmission by the communication device, the screenshot so that the pronouns in the communication dialogue identify the parties represented by the pronouns in the communication dialogue.

In one or more embodiments, the extracting is performed using artificial intelligence (AI) processing. The method may also include determining, by the one or more processors, whether the communication dialogue is a one-to-one conversation or a group conversation. In one or more embodiments, the annotating occurs only when the communication dialogue is a group conversation.

Additionally, in some embodiments the method involves determining, by the one or more processors, whether the remote electronic device belongs to a third party who was uninvolved in the communication dialogue. In some embodiments, the annotating occurs only when the third party was uninvolved with the communication dialogue.

In still other embodiments, the annotating comprises overlays presented on the screenshot with the overlays identifying the parties represented by the pronouns in the communication dialogue. In one or more embodiments the overlays partially overlap the pronouns in the communication dialogue on a one-to-one basis.

Alternatively, the annotating may involve replacing the pronouns in the communication dialogue with names identifying the parties represented by the pronouns in the communication dialogue. In one or more embodiments, the method may also include reversing a geometric alignment of communication instances of the communication dialogue depicted in the screenshot, which occurs only when the remote electronic device belongs to an individual involved in the communication dialogue.

In some embodiments, the annotating may further involve changing the color of communication instances of the communication dialogue depicted in the screenshot or reversing the pronouns in the communication dialogue. The method can also include obscuring, by the one or more processors prior to the communication device transmitting the screenshot, private information of original participants of the communication dialogue depicted in the screenshot.

Advantageously, receiving user input requesting the transmission of a screenshot of a communication dialogue to a remote electronic device, and extracting identifiers of parties represented by pronouns in the communication dialogue, allows the system to accurately identify and label the participants in the conversation. This modification of the screenshot prior to transmission ensures that the pronouns in the communication dialogue are replaced with the actual names of the parties involved. This process eliminates ambiguity and confusion for the recipient of the screenshot, who may not be familiar with the context or the participants of the original conversation. By providing clear identification of the parties, the method enhances the clarity and comprehensibility of shared screenshots, thereby improving communication and reducing the likelihood of misunderstandings. This is particularly useful in scenarios where screenshots are shared for seeking advice, providing documentation, or clarifying misunderstandings.

Embodiments of the disclosure contemplate that the problem with taking screenshots from a personal perspective arises from ambiguity and potential confusion for other parties involved. The labeling problem in screenshots occurs due to the use of ambiguous or unclear identifiers.

Specifically, the use of pronouns such as “you” within the conversation context can be unclear when viewed by someone not involved in the conversation. This makes discerning who the pronouns refer to challenging, causing confusion.

Additionally, without clear labels or identifiers for each participant, viewers may struggle to distinguish who said what, especially in one-on-one chats or group conversations. In some applications, even the label “you” is missing, further exacerbating the issue.

This labeling problem creates confusion and makes understanding the roles and identities of the participants difficult for individuals outside the conversation, potentially leading to misunderstandings or misinterpretations of the conversation's content. For example, a third party receiving a screenshot would not know who “you” refers to or who sent the last few messages at the end. This lack of clarity can result in significant miscommunication and errors in interpreting the shared information.

Consider the following use case that illustrates this problem: Chris and John engaged in a heated debate, leading Chris to share an old screenshot to support his stance. Hours later, John rekindled the discussion, referencing the same screenshot Chris had provided.

Confidently, John used the screenshot to back his argument. However, upon closer examination, John realized that the pronoun “you” in the chat referred to Chris, not him.

This misunderstanding highlights the ambiguity and potential confusion arising from the use of unclear identifiers in shared screenshots. The situation results in an embarrassed silence as John comprehended his mistake. He had inadvertently used Chris's own words against him. John admitted the mix-up, chuckling at the irony. This incident serves as a lesson on the pitfalls of interpreting old conversations without careful consideration. The example underscores the need for clear identification of participants in shared screenshots to prevent such misunderstandings and ensure accurate communication.

Advantageously, embodiments of the disclosure provide a solution to this problem. In one or more embodiments, the solution involves detecting the capture of a screenshot of a communication dialogue on an electronic device. The system, optionally using artificial intelligence-based screenshot techniques, extracts information from the screenshot.

In one or more embodiments, the system determines whether the communication dialogue belongs to a one-to-one conversation or a group conversation. In one or more embodiments, the system extracts and stores the exact sender information of each message in the communication dialogue as metadata.

In one or more embodiments, when the screenshot is shared with a third contact who is not part of the original communication dialogue, the system annotates the sender information associated with each dialogue in the screenshot. The annotation process may include modifying the annotations depending on the recipient of the screenshot.

For instance, if the recipient is part of the communication dialogue, the system may add “you” to any messages sent by the user for easier consumption. The system may also extract the different user accounts present in the communication dialogue and modify those with contact details present in the recipient's contact database. This ensures that the recipient can clearly understand who sent each message, thereby reducing ambiguity and potential confusion.

In some embodiments, the system may present overlays on the screenshot with the overlays identifying the parties represented by the pronouns in the communication dialogue. The overlays may partially overlap the pronouns in the communication dialogue on a one-to-one basis. Alternatively, the system may replace the pronouns in the communication dialogue with names identifying the parties represented by the pronouns. The system may also reverse the geometric alignment of communication instances of the communication dialogue depicted in the screenshot, which occurs only when the remote electronic device belongs to an individual involved in the communication dialogue.

For instance, in one or more embodiments an electronic device comprises a user interface, a communication device, and one or more processors operable with the user interface and the communication device. The one or more processors are configured to, in response to the user interface receiving user input capturing a screenshot of a communication dialogue, identify parties engaged in the communication dialogue represented by pronouns in the communication dialogue from a contact database accessible to the one or more processors. In one or more embodiments, the one or more processors modify the screenshot to cause the parties identified by the pronouns to be identified by name.

In one or more embodiments, the one or more processors are further configured to present a preview of the screenshot after modification prior to the communication device transmitting the screenshot. This preview allows the user to verify the modifications and ensure that the annotations accurately reflect the identities of the participants in the communication dialogue. The preview feature enhances the user experience by providing an opportunity to review and confirm the changes before sharing the screenshot with others.

Additionally, the one or more processors can be configured to log modifications to the screenshot and attach the log of modifications to the screenshot after modification as metadata. This logging process ensures transparency and traceability of the changes made to the screenshot. The metadata provides a record of the modifications, which can be useful for future reference or verification purposes. The combination of these features ensures that the electronic device provides a clear and accurate representation of the communication dialogue, reducing ambiguity and potential confusion for recipients of the shared screenshot.

By leveraging a contact database accessible to the processors, the device can accurately map pronouns to specific individuals, thereby enhancing the clarity and comprehensibility of the shared screenshot. This is particularly beneficial in scenarios where the context of the conversation is critical, such as in professional or legal communications, or when seeking advice or opinions.

The modification of the screenshot prior to transmission ensures that the recipient can easily understand who said what, improving the overall user experience and reducing the likelihood of misunderstandings. This approach also supports the integrity of the communication by providing a clear and accurate representation of the dialogue, which is essential for maintaining trust and transparency in digital interactions

In one or more embodiments in an electronic device a method involves detecting, by one or more processors, the capture of a screenshot depicting a communication dialogue. In one or more embodiments, the method extracts identifiers of persons represented by at least some words depicted in the communication dialogue.

In one or more embodiments, the method includes annotating, by the one or more processors, the at least some words with the identifiers of the persons to create an annotated screenshot. The system then causes, by the one or more processors, a communication device to transmit the annotated screenshot to a remote electronic device across a network.

In one or more embodiments, the method further comprises determining, by the one or more processors, whether the remote electronic device belongs to a participant of the communication dialogue and whether the communication dialogue is a one-to-one conversation. When the remote electronic device belongs to the participant of the communication dialogue and the communication dialogue is a one-to-one conversation, the annotating comprises replacing first person pronouns with second person pronouns and vice versa in one or more embodiments. This ensures that the pronouns in the communication dialogue accurately reflect the perspective of the recipient, thereby reducing ambiguity and potential confusion.

Detecting the capture of a screenshot depicting communication dialogue and extracting identifiers of persons represented by words in the communication dialogue allows the system to accurately identify and label the participants in the conversation. Annotating the words with the identifiers of the persons to create an annotated screenshot ensures that the pronouns in the communication dialogue are replaced with the actual names of the parties involved. This modification of the screenshot prior to transmission ensures that the recipient can easily understand who said what, improving the overall user experience and reducing the likelihood of misunderstandings.

By causing the communication device to transmit the annotated screenshot to a remote electronic device across a network, the method enhances the clarity and comprehensibility of shared screenshots, thereby improving communication and reducing the likelihood of misunderstandings. This is particularly useful in scenarios where screenshots are shared for seeking advice, providing documentation, or clarifying misunderstandings. Other advantages will be described below. Still others will be obvious to those of ordinary skill in the art having the benefit of this disclosure.

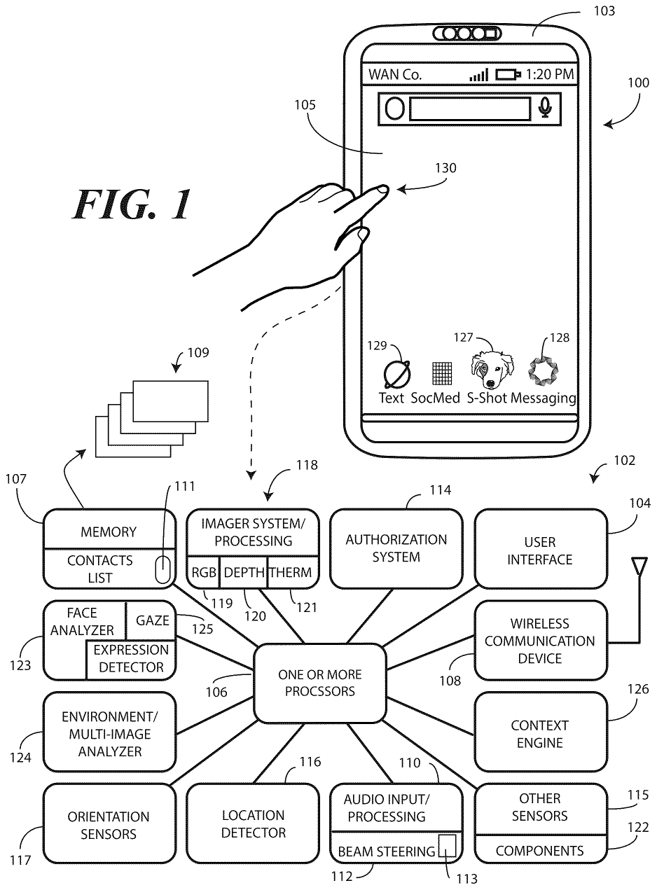

Turning now to FIG. 1, illustrated therein is one explanatory electronic device 100 in accordance with one or more embodiments of the disclosure. Also illustrated in FIG. 1 is one explanatory block diagram schematic 102 of the explanatory electronic device 100 of FIG. 1. In one or more embodiments, the block diagram schematic 102 is configured as a printed circuit board assembly disposed within a housing 103 of the electronic device 100. Various components can be electrically coupled together by conductors, or a bus disposed along one or more printed circuit boards.

The illustrative block diagram schematic 102 of FIG. 1 includes many different components. Embodiments of the disclosure contemplate that the number and arrangement of such components can change depending on the particular application. Accordingly, electronic devices configured in accordance with embodiments of the disclosure can include some components that are not shown in FIG. 1, and other components that are shown may not be needed and can therefore be omitted.

The illustrative block diagram schematic 102 includes a user interface 104. In one or more embodiments, the user interface 104 includes a display 105, which may optionally be touch sensitive. In one embodiment, users can deliver user input to the display 105 of such an embodiment by delivering touch input from a finger, stylus, or other objects disposed proximately with the display 105.

In one embodiment, the display 105 is configured as an active matrix organic light emitting diode (AMOLED) display. However, it should be noted that other types of displays, including liquid crystal displays, suitable for use with the user interface 104 would be obvious to those of ordinary skill in the art having the benefit of this disclosure.

In one embodiment, the electronic device includes one or more processors 106. In one embodiment, the one or more processors 106 can include an application processor and, optionally, one or more auxiliary processors. One or both of the application processor or the auxiliary processor(s) can include one or more processors.

One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 102.

Each of the application processor and the auxiliary processor(s) can be configured to process and execute executable software code to perform the various functions of the electronic device with which the block diagram schematic 102 operates. A storage device, such as memory 107, can optionally store the executable software code used by the one or more processors 106 during operation.

In one or more embodiments, the one or more processors 106 are responsible for running the operating system environment. The operating system environment can include a kernel, one or more drivers, and an application service layer, and an application layer. The operating system environment can be configured as executable code operating on one or more processors 106 or control circuits of the electronic device 100.

The application service layer can be responsible for executing application service modules. The application service modules may support one or more applications or “apps.” Examples of such applications include a cellular telephone application for making voice telephone calls, a web browsing application configured to allow the user to view webpages on the display 105 of the electronic device 100, an electronic mail application configured to send and receive electronic mail, a photo application configured to organize, manage, and present photographs on the display 105 of the electronic device 100, and a camera application for capturing images with the imager 119. Collectively, these applications constitute an “application suite.”

In one or more embodiments, these applications comprise one or more messaging applications 128, one example of which includes a text messaging application 129. In one or more embodiments, the one or more processors 106 are capable of using a screenshot feature 127 to capture screenshots of content presented on the display 105.

The one or more processors 106 of FIG. 1 can use the screenshot feature 127 to capture screenshots of content presented on the display 105 by executing a series of steps that involve detecting user input, processing the display content, and storing the captured image. Here is a simplified explanation of how this process can works in one or more embodiments:

In one or more embodiments, the user interface 104, which includes the display 105, receives user input 130 indicating the desire to capture a screenshot. This user input 130 can be a specific gesture, button press, or a combination of actions predefined by the device's operating system.

In one or more embodiments, once the user input 130 is detected, the one or more processors 106 receive signals from the user interface 104 corresponding to the user input 130. In one or more embodiments, these processors are responsible for managing the device's operations and executing software instructions. The processors access the current content being displayed on the display 105.

In one or more embodiments, the one or more processors 106 then capture the image of the content displayed on the display 105. In one or more embodiments, this involves copying the pixel data from the display buffer, which is the memory area where the display content is stored.

In one or more embodiments, after capturing the image, the one or more processors 106 store the screenshot in the device's memory 107. This storage can be temporary or permanent, depending on the user's actions and the device's configuration.

In one or more embodiments, the one or more processors 106 may also perform additional processing on the screenshot, such as annotating the screenshot with metadata, modifying the image, or preparing the screenshot for sharing. This processing can include identifying and labeling participants in a communication dialogue, as described in the patent draft.

The user interface 104 may provide feedback to the user, such as a visual or auditory notification, indicating that the screenshot has been successfully captured and stored. In summary, the one or more processors 106 detect user input requesting a screenshot, capture the image of the content displayed on the display 105, and store the captured image in the device's memory. This process allows users to easily capture and save images of their screen content for various purposes.

In one or more embodiments the user interface 104 can then receive other user input requesting a communication device 108 of the electronic device 100 transmit the screenshot to a remote electronic device. In one or more embodiments, the one or more processors 106 are configured to, in response to the user interface receiving user input 130 capturing a screenshot of a communication dialogue, such as that generated in the messaging application 128 or text messaging application 129, identify parties engaged in the communication dialogue represented by pronouns in the communication dialogue from a contact database accessible to the one or more processors 106. In one or more embodiments, the one or more processors modify the screenshot to cause the parties identified by the pronouns to be identified by name.

In one or more embodiments, the one or more processors 106 are further configured to present a preview of the screenshot on the user interface 104 after modification and prior to the communication device 108 transmitting the screenshot. In one or more embodiments, the one or more processors 106 are further configured to log modifications to the screenshot and attach the log of modifications to the screenshot after modification as metadata. In one or more embodiments, modifications of the screenshot are pursuant to modification instructions defined by a user in the electronic device 100, with those modification instructions comprising one of presenting overlays over the screenshot or changing text of the screenshot.

In this illustrative embodiment, the block diagram schematic 102 also includes a communication circuit 108 that can be configured for wired or wireless communication with one or more other devices or networks. The networks can include a wide area network, a local area network, and/or personal area network. The communication circuit 108 may also utilize wireless technology for communication, such as, but are not limited to, peer-to-peer or ad hoc communications such as HomeRF, Bluetooth and IEEE 802.11, and other forms of wireless communication such as infrared technology. The communication circuit 108 can include wireless communication circuitry, one of a receiver, a transmitter, or transceiver, and one or more antennas.

In one embodiment, the one or more processors 106 can be responsible for performing the primary functions of the electronic device with which the block diagram schematic 102 is operational. For example, in one embodiment the one or more processors 106 comprise one or more circuits operable with the user interface 104 to present presentation information to a user and capture screenshots of the same in response to user input 130. The executable software code used by the one or more processors 106 can be configured as one or more modules 109 that are operable with the one or more processors 106. Such modules 109 can store instructions, control algorithms, and so forth.

In one or more embodiments, the block diagram schematic 102 includes an audio input/processor 110. The audio input/processor 110 is operable to receive audio input from an environment about the electronic device 100. The audio input/processor 110 can include hardware, executable code, and speech monitor executable code in one embodiment. The audio input/processor 110 can be operable with one or more predefined authentication references 111 stored in memory 107.

With reference to audio input, the predefined authentication references 111 can comprise representations of basic speech models, representations of trained speech models, or other representations of predefined audio sequences that are used by the audio input/processor 110 to receive and identify voice commands that are received with audio input captured by an audio capture device. In one embodiment, the audio input/processor 110 can include a voice recognition engine. Regardless of the specific implementation utilized in the various embodiments, the audio input/processor 110 can access various speech models stored with the predefined authentication references 111 to identify speech commands.

The audio input/processor 110 can include a beam steering engine 112 comprising one or more microphones 113. Input from the one or more microphones 113 can be processed in the beam steering engine 112 such that the one or more microphones define a virtual microphone. This virtual microphone can define an acoustic reception cone that can be virtually “steered” around the electronic device 100. Alternatively, actual steering can occur as well, such as switching between a left and right microphone or a front and back microphone or switching various microphones ON and OFF individually. In one or more embodiments, two or more microphones 113 can be included for selective beam steering by the beam steering engine 112.

Illustrating by example, a first microphone can be located on a first side of the electronic device 100 for receiving audio input from a first direction, while a second microphone can be placed on a second side of the electronic device 100 for receiving audio input from a second direction. These microphones can be “steered” by selectively turning them ON and OFF.

The beam steering engine 112 can then select between the first microphone and the second microphone to beam steer audio reception toward an object, such as a user delivering audio input. This beam steering can be responsive to input from other sensors, such as imagers, facial depth scanners, thermal sensors, or other sensors.

For example, an imager can estimate a location of a person's face and deliver signals to the beam steering engine 112 alerting it in which direction to focus the acoustic reception cone and/or steer the first microphone and the second microphone, thereby adding confirmation to audio steering and saving time. Where multiple people are around the electronic device 100, as was the case in FIG. 1, this steering advantageously directs a beam reception cone to the authorized user.

Alternatively, the beam steering engine 112 processes and combines the signals from two or more microphones to perform beam steering. The one or more microphones 113 can be used for voice commands. In response to control of the one or more microphones 113 by the beam steering engine 112, a user location direction can be determined. The beam steering engine 112 can then select between the first microphone and the second microphone to beam steer audio reception toward the user. Alternatively, the audio input/processor 110 can employ a weighted combination of the microphones to beam steer audio reception toward the user.

In one embodiment, the audio input/processor 110 is configured to implement a voice control feature that allows a user to speak a specific device command to cause the one or more processors 106 to execute a control operation. For example, the user may say, “Authenticate Me Now.” This statement comprises a device command requesting the one or more processors to cooperate with the authentication system 114 to authenticate a user. Consequently, this device command can cause the one or more processors 106 to access the authentication system 114 and begin the authentication process. In short, in one embodiment the audio input/processor 110 listens for voice commands, processes the commands and, in conjunction with the one or more processors 106, performs a touchless authentication procedure in response to voice input.

The one or more processors 106 can perform filtering operations on audio input received by the audio input/processor 110. For example, in one embodiment the one or more processors 106 can filter the audio input into authorized user generated audio input, i.e., first audio input, and other audio input, i.e., second audio input.

Various sensors 115 can be operable with the one or more processors 106. A first example of a sensor that can be included with the various sensors 115 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 106, to detect an object in close proximity with - or touching - the surface of the display 105 or the housing 103 of the electronic device 100 by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques.

Another example of a sensor 115 is a geo-locator that serves as a location detector 116. In one embodiment, location detector 116 is able to determine location data when authenticating a user. Location can be determined by capturing the location data from a constellation of one or more earth orbiting satellites, or from a network of terrestrial base stations to determine an approximate location. The satellite positioning systems based location fixes of the location detector 116 autonomously or with assistance from terrestrial base stations, for example those associated with a cellular communication network or other ground based network, or as part of a Differential Global Positioning System (DGPS), as is well known by those having ordinary skill in the art. The location detector 116 may also be able to determine location by locating or triangulating terrestrial base stations of a traditional cellular network, or from other local area networks, such as Wi-Fi networks.

One or more motion detectors can be configured as an orientation detector 117 that determines an orientation and/or movement of the electronic device 100 in three-dimensional space. Illustrating by example, the orientation detector 117 can include an accelerometer, gyroscopes, or other device to detect device orientation and/or motion of the electronic device 100. Using an accelerometer as an example, an accelerometer can be included to detect motion of the electronic device. Additionally, the accelerometer can be used to sense some of the gestures of the user, such as one talking with their hands, running, or walking.

The orientation detector 117 can determine the spatial orientation of an electronic device 100 in three-dimensional space by, for example, detecting a gravitational direction. In addition to, or instead of, an accelerometer, an electronic compass can be included to detect the spatial orientation of the electronic device relative to the earth's magnetic field. Similarly, one or more gyroscopes can be included to detect rotational orientation of the electronic device 100.

The authentication system 114 is operable with the one or more processors 106. A first authenticator 118 of the authentication system 114 can include an imager 119, a depth imager 120, and, optionally, a thermal sensor 121. In one embodiment, the imager 119 comprises a two-dimensional imager configured to receive at least one image of a person within an environment of the electronic device 100. In one embodiment, the imager 119 comprises a two-dimensional Red-Green-Blue (RGB) imager. In another embodiment, the imager 119 comprises an infrared imager. Other types of imagers suitable for use as the imager 119 of the authentication system will be obvious to those of ordinary skill in the art having the benefit of this disclosure.

The thermal sensor 121 can also take various forms. In one embodiment, the thermal sensor 121 is simply a proximity sensor component included with the other components 122 of the electronic device 100. In another embodiment, the thermal sensor 121 comprises a simple thermopile. In another embodiment, the thermal sensor 121 comprises an infrared imager that captures the amount of thermal energy emitted by an object. Other types of thermal sensors 121 will be obvious to those of ordinary skill in the art having the benefit of this disclosure.

The depth imager 120 can take a variety of forms. In a first embodiment, the depth imager 120 comprises a pair of imagers separated by a predetermined distance, such as three to four images. This “stereo” imager works in the same way the human eyes do in that it captures images from two different angles and reconciles the two to determine distance.

In another embodiment, the depth imager 120 employs a structured light laser. The structured light laser projects tiny light patterns that expand with distance. These patterns land on a surface, such as a user's face, and are then captured by an imager. By determining the location and spacing between the elements of the pattern, three-dimensional mapping can be obtained.

In still another embodiment, the depth imager 120 comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained. Regardless of embodiment, the depth imager adds a third “z-dimension” to the x-dimension and y-dimension defining the two-dimensional image captured by the imager 119, thereby enhancing the security of using a person's face as their password in the process of authentication by facial recognition.

In one or more embodiments, the authentication system 114 can be operable with a face analyzer 123 and an environmental analyzer 124. The face analyzer 123 and/or environmental analyzer 124 can be configured to process an image or depth scan of an object and determine whether the object matches predetermined criteria by comparing the image or depth scan to one or more predefined authentication references 111 stored in memory 107.

For example, the face analyzer 123 and/or environmental analyzer 124 can operate as an authentication module configured with optical and/or spatial recognition to identify objects using image recognition, character recognition, visible recognition, facial recognition, color recognition, shape recognition, and the like. Advantageously, the face analyzer 123 and/or environmental analyzer 124, operating in tandem with the authentication system 114, can be used as a facial recognition device to determine the identity of one or more persons detected about the electronic device 100.

In one embodiment when the authentication system 114 detects a person, one or both of the imager 119 and/or the depth imager 120 can capture a photograph and/or depth scan of that person. The authentication system 114 can then compare the image and/or depth scan to one or more predefined authentication references 111 stored in the memory 107. This comparison, in one or more embodiments, is used to confirm beyond a threshold authenticity probability that the person's face—both in the image and the depth scan-sufficiently matches one or more of the predefined authentication references 111 stored in the memory 107 to authenticate a person as an authorized user of the electronic device 100.

Beneficially, this optical recognition performed by the authentication system 114 operating in conjunction with the face analyzer 123 and/or environmental analyzer 124 allows access to the electronic device 100 only when one of the persons detected about the electronic device 100 are sufficiently identified as an authorized user of the electronic device 100.

Accordingly, in one or more embodiments the one or more processors 106, working with the authentication system 114 and the face analyzer 123 and/or environmental analyzer 124 can determine whether at least one image captured by the imager 119 matches a first predefined criterion, whether at least one facial depth scan captured by the depth imager 120 matches a second predefined criterion, and whether the thermal energy identified by the thermal sensor 121 matches a third predefined criterion, with the first criterion, second criterion, and third criterion being defined by the reference files and predefined temperature range.

The first criterion may be a skin color, eye color, and hair color, while the second criterion is a predefined facial shape, ear size, and nose size. The third criterion may be a temperature range of between 95 and 101 degrees Fahrenheit. In one or more embodiments, the one or more processors 106 authenticate a person as an authorized user of the electronic device 100 when the at least one image matches the first predefined criterion, the at least one facial depth scan matches the second predefined criterion, and the thermal energy matches the third predefined criterion.

In one or more embodiments, a user can “train” the electronic device 100 by storing predefined authentication references 111 in the memory 107 of the electronic device 100. These predefined authentication references 111 can be audio references, image references, depth scan references, or other types of references. Illustrating by example, the one or more processors 106 of the electronic device 100 may cause the one or more microphones 113 to capture audio samples of people situated within the environment of the electronic device 100 so that the same people can be identified at another time.

The audio input/processing module 110 can capture audio signals from the environment using one or more microphones 113. These audio signals can then be processed to extract relevant audio features. The audio input/processing module 110 can compare these extracted audio features to one or more predefined authentication references 111 stored in the memory 107. These predefined authentication references 111 may include voice samples from previous interactions, voice messages, or manually uploaded voice samples. By comparing the captured audio features to the stored references, the system can identify individuals present within the environment of the electronic device 100.

The audio input/processing module 110 can also employ a voice recognition engine to analyze the captured audio signals. This engine, where used, can extract voice recognition features and generate a voiceprint for each detected voice. The voice recognition engine can then compare these voiceprints to the predefined authentication references 111. If a match is found, the system can identify the individual associated with the voiceprint. This process allows the system to dynamically and contextually identify individuals present during a financial transaction or other events, ensuring accurate identification of participants.

In scenarios where multiple individuals are present, the audio input/processing module 110 can distinguish between different voices by analyzing voice characteristics such as pitch, tone, and speech patterns. The system can then cross-reference these characteristics with the predefined authentication references 111 to accurately identify each individual. This capability is particularly useful in environments where participants may join or leave at different times, ensuring that the system maintains an up-to-date and accurate list of individuals present.

Similarly, a user may take a series of pictures. They can include identifiers of special features such as eye color, sink color, air color, weight, and height. They can include the user standing in front of a particular wall, which is identifiable by the environmental analyzer from images captured by the imager 119. They can include the user raising a hand, touching hair, or looking in one direction, such as in a profile view. These can then be stored as predefined authentication references 111 in the memory 107 of the electronic device 100.

A gaze detector 125 can be operable with the authentication system 114 operating in conjunction with the face analyzer 123. The gaze detector 125 can comprise sensors for detecting the user's gaze point. The gaze detector 125 can optionally include sensors for detecting the alignment of a user's head in three-dimensional space. Electronic signals can then be processed for computing the direction of user's gaze in three-dimensional space. The gaze detector 125 can further be configured to detect a gaze cone corresponding to the detected gaze direction, which is a field of view within which the user may easily see without diverting their eyes or head from the detected gaze direction. The gaze detector 125 can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector 125 of FIG. 1.

The face analyzer 123 can include its own image/gaze detection-processing engine as well. The image/gaze detection-processing engine can process information to detect a user's gaze point. The image/gaze detection-processing engine can optionally also work with the depth scans to detect an alignment of a user's head in three-dimensional space. Electronic signals can then be delivered from the imager 119 or the depth imager 120 for computing the direction of user's gaze in three-dimensional space. The image/gaze detection-processing engine can further be configured to detect a gaze cone corresponding to the detected gaze direction, which is a field of view within which the user may easily see without diverting their eyes or head from the detected gaze direction. The image/gaze detection-processing engine can be configured to alternately estimate gaze direction by inputting images representing a photograph of a selected area near or around the eyes. It can also be valuable to determine if the user wants to be authenticated by looking directly at device. The image/gaze detection-processing engine can determine not only a gazing cone but also if an eye is looking in a particular direction to confirm user intent to be authenticated.

Other components 122 operable with the one or more processors 106 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 122 can also include proximity sensors. The proximity sensors fall into one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 103 of the electronic device 100. In one embodiment, the signal receiver is an infrared signal receiver to receive an infrared emission from an object such as a human being when the human is proximately located with the electronic device 100. In one or more embodiments, the proximity sensor component is configured to receive infrared wavelengths of about four to about ten micrometers. This wavelength range is advantageous in one or more embodiments in that it corresponds to the wavelength of heat emitted by the body of a human being.

Additionally, detection of wavelengths in this range is possible from farther distances than, for example, would be the detection of reflected signals from the transmitter of a proximity detector component. In one embodiment, the proximity sensor components have a relatively long detection range so as to detect heat emanating from a person's body when that person is within a predefined thermal reception radius. For example, the proximity sensor component may be able to detect a person's body heat from a distance of about fifteen feet in one or more embodiments. The ten-foot dimension can be extended as a function of designed optics, sensor active area, gain, lensing gain, and so forth.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

In one embodiment, the signal receiver of each proximity sensor component can operate at various sensitivity levels so as to cause the at least one proximity sensor component to be operable to receive the infrared emissions from different distances. For example, the one or more processors 106 can cause each proximity sensor component to operate at a first “effective” sensitivity so as to receive infrared emissions from a first distance. Similarly, the one or more processors 106 can cause each proximity sensor component to operate at a second sensitivity, which is less than the first sensitivity, so as to receive infrared emissions from a second distance, which is less than the first distance. The sensitivity change can be affected by causing the one or more processors 106 to interpret readings from the proximity sensor component differently.

By contrast, proximity detector components include a signal emitter and a corresponding signal receiver, which constitute an “active IR” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other components 122 can optionally include a barometer operable to sense changes in air pressure due to elevation changes or differing pressures of the electronic device 100. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

The other components 122 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device.

A context engine 126 can then be operable with the various sensors to detect, infer, capture, and otherwise determine persons and actions that are occurring in an environment about the electronic device 100. For example, where included one embodiment of the context engine 126 determines assessed contexts and frameworks using adjustable algorithms of context assessment employing information, data, and events. These assessments may be learned through repetitive data analysis. Alternatively, a user may employ the user interface 104 to enter various parameters, constructs, rules, and/or paradigms that instruct or otherwise guide the context engine 126 in detecting multi-modal social cues, emotional states, moods, and other contextual information. The context engine 126 can comprise an artificial neural network or other similar technology in one or more embodiments.

In one or more embodiments, the context engine 126 is operable with the one or more processors 106. In some embodiments, the one or more processors 106 can control the context engine 126. In other embodiments, the context engine 126 can operate independently, delivering information gleaned from detecting multi-modal social cues, emotional states, moods, and other contextual information to the one or more processors 106. The context engine 126 can receive data from the various sensors. In one or more embodiments, the one or more processors 106 are configured to perform the operations of the context engine 126.

In one or more embodiments, the one or more processors 106 can be operable with the various authenticators of the authentication system 114. For example, the one or more processors 106 can be operable with a first authenticator and a second authenticator. Where more authenticators are included in the authentication system 114, the one or more processors 106 can be operable with these authenticators as well.

As will be described in more detail below, in one or more embodiments the one or more processors 106 are configured to detect the capture of a screenshot depicting communication dialogue. In one or more embodiments, the one or more processors 106 then extract identifiers of persons represented by at least some words depicted in the communication dialogue.

In one or more embodiments, the one or more processors 106 further annotate the at least some words with the identifiers of the persons to create an annotated screenshot. The one or more processors 106 can then cause the communication device 108 to transmit the annotated screenshot to a remote electronic device across a network.

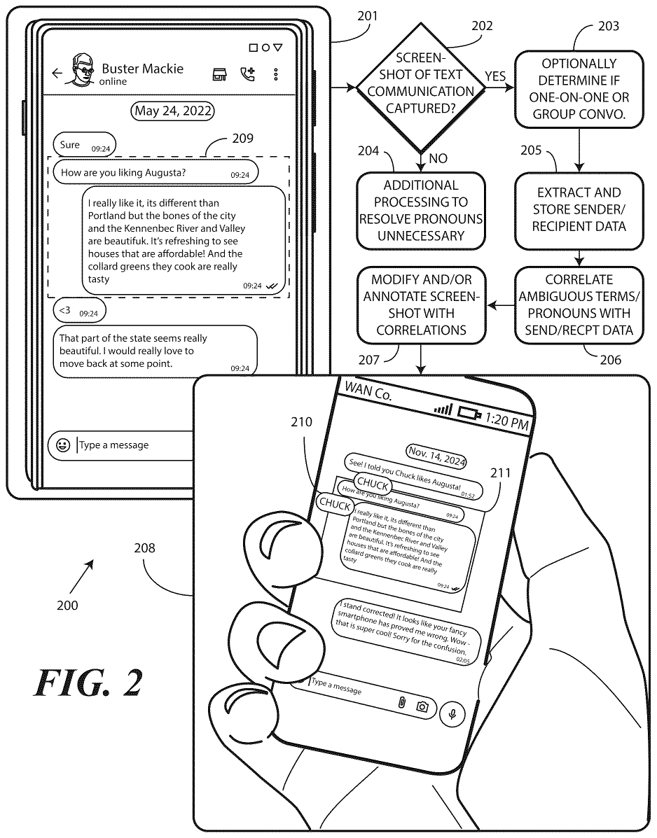

In one or more embodiments, the one or more processors 106 further use signals from the communication device 108 to determine the remote electronic device belongs to a participant of the communication dialogue and whether the communication dialogue is a one-to-one conversation. In one or more embodiments, when the remote electronic device belongs to the participant of the communication dialogue and the communication dialogue is a one-to-one conversation, the annotating comprises replacing first person pronouns with second person pronouns and vice versa. This ensures that the pronouns in the communication dialogue accurately reflect the perspective of the recipient, thereby reducing ambiguity and potential confusion. A method illustrating how this can occur is shown in FIG. 2.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components, and still be within the scope of the present disclosure.

Embodiments of the disclosure contemplate that capture of a screenshot can be initiated for any number of a variety of reasons. Additionally, screenshots can be delivered to a variety of people. Moreover, the screenshot may be sent to recipients other than those who were involved in the conversations depicted in the screenshots. Examples of each of these variations will be described in more detail with reference to the figures that follow.

Illustrating by example, turning now to FIG. 2, illustrated therein is one explanatory system and method 200 configured in accordance with one or more embodiments of the disclosure. Beginning at step 201, an electronic device configured in accordance with one or more embodiments of the disclosure is illustrated with its display presenting a communication dialogue that forms a portion of a text string in a text application operating on one or more processors of the electronic device.

As shown at step 201, there are multiple pronouns in the communication dialogue. Illustrating by example, one portion of the communication dialogue states, “how are you liking Augusta?” Similarly, another portion says, “I really like it.”

Pronouns such as “I” and “you” in the communication dialogue shown at step 201 of FIG. 2 can cause ambiguity when viewed by individuals not involved in the original conversation. The use of these pronouns without clear context or identifiers makes discerning the referents challenging for third parties, leading to potential confusion.

For instance, in a shared screenshot, the pronoun “I” could refer to any participant in the conversation, and “you” could refer to any recipient of the messages. This lack of clarity can result in misunderstandings about who made specific statements or who is being addressed in the conversation.

When a screenshot 209 of a communication dialogue is shared with a third party, the ambiguity of pronouns like “I” and “you” becomes more pronounced. The third party, unfamiliar with the context and participants of the original conversation, may misinterpret the roles and identities of the individuals involved. This can lead to incorrect assumptions about the content and intent of the messages.

For example, a statement such as “I really like the proposal” could be attributed to the wrong person, altering the perceived meaning of the conversation. Similarly, a question like “How are you liking Augusta?” could be misinterpreted regarding who is asking and who is being asked.

To address this issue, the method 200 of FIG. 2 extracts identifiers of parties represented by pronouns in the communication dialogue. By annotating the pronouns with the actual names of the participants, method 200 eliminates ambiguity and ensures that the roles and identities of the individuals are clearly understood. This modification of the screenshot prior to transmission provides a clear and accurate representation of the conversation, reducing the likelihood of misunderstandings and enhancing the clarity of the shared communication.

At step 201, the electronic device receives, at a user interface, user input requesting a communication device of the electronic device transmit a screenshot 209 of communication dialogue to a remote electronic device, which is shown in step 208. Decision 202 detects, by one or more processors, capture of the screenshot 209 depicting communication dialogue. If no screenshot is captured, normal device operation occurs at step 204.

In this example, since the screenshot 209 is captured, the method 200 moves to optional step 203. In one or more embodiments, step 203 determines, by the one or more processors, whether the communication dialogue is a one-to-one conversation or a group conversation. The illustrative communication dialogue shown at step 201 is a one-on-one conversation.

At step 205, the one or more processors extract, from application data of an application from which the screenshot was taken, which in this case is a text messaging application, identifiers of parties represented by pronouns in the communication dialogue. In one or more embodiments, the extracting is performed using artificial intelligence (AI) processing. In one or more embodiments, step 205 comprises extracting, by the one or more processors, identifiers of persons represented by at least some words depicted in the communication dialogue.

In step 206 of FIG. 2, the system correlates any ambiguous terms and/or pronouns in one or both of the communication dialogue or the send or receipt data with identifications of parties represented by the pronouns in one or both of the communication dialogue or the send or receipt data. This correlation process can involve several techniques to ensure accurate identification of the parties involved in the communication dialogue. Others will be obvious to those of ordinary skill in the art having the benefit of this disclosure.

One technique involves natural language processing (NLP) algorithms that analyze the context of the conversation to determine the referents of ambiguous terms and pronouns. By examining the surrounding text and the structure of the dialogue, the NLP algorithms can infer the most likely identities of the parties represented by the pronouns.

Another technique employs machine learning models trained on large datasets of annotated conversations. These models can recognize patterns and relationships between words and phrases, allowing them to predict the identities of parties based on the context and usage of pronouns. The machine learning models continuously improve their accuracy through training on new data, making them highly effective in diverse communication scenarios.

A third technique involves leveraging metadata associated with the communication dialogue, such as timestamps, sender and recipient information, and contact details from the user's address book. By cross-referencing this metadata with the content of the conversation, the system can accurately map pronouns to specific individuals. This method ensures that the identification process is grounded in concrete data, reducing the likelihood of errors.

Each of these techniques offers distinct advantages. NLP algorithms provide a robust understanding of the conversation context, making them effective in complex dialogues with nuanced language. Machine learning models offer scalability and adaptability, improving their performance over time as they are exposed to more data. Metadata-based correlation provides a reliable and data-driven approach, ensuring that the identification process is based on verifiable information. By combining these techniques, the system can achieve a high level of accuracy in identifying parties represented by ambiguous terms and pronouns, enhancing the clarity and comprehensibility of shared screenshots.

Step 207 comprises modifying, by the one or more processors prior to transmission by the communication device, the screenshot 209 so that the pronouns in the communication dialogue identify the parties represented by the pronouns in the communication dialogue. In one or more embodiments, this modification comprises annotating, by the one or more processors, the at least some words with the identifiers of the persons to create an annotated screenshot 211.

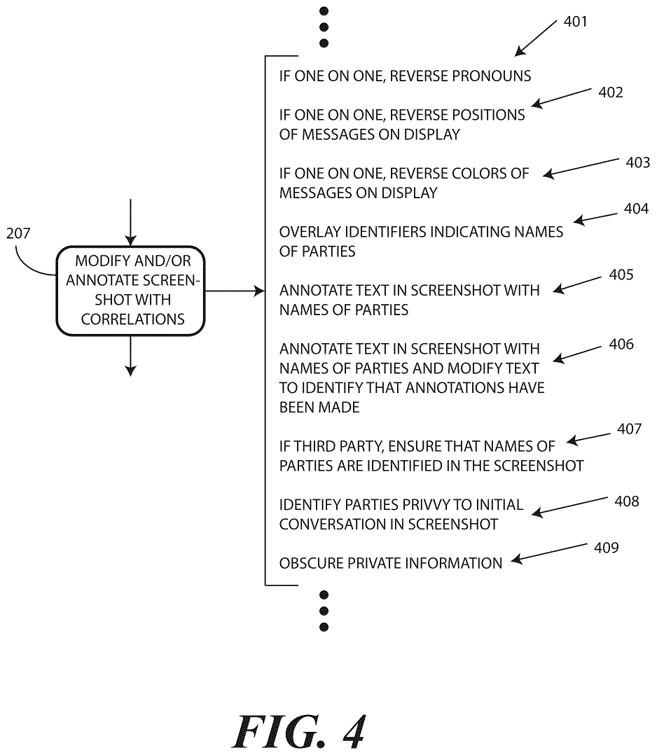

The annotation and/or modification can occur in a variety of ways. Turning now briefly to FIG. 4, illustrated therein are a few such ways. Others will be obvious to those of ordinary skill in the art having the benefit of this disclosure.

In one or more embodiments, the modification and/or annotation at step 207 comprises reversing 401 the pronouns in the communication dialogue. Reversing 401 the pronouns in the communication dialogue at step 207 of FIG. 4 removes ambiguity by ensuring that the pronouns accurately reflect the perspective of the recipient of the annotated screenshot.

In one or more embodiments, this process involves changing first-person pronouns to second-person pronouns and vice versa, depending on the context of the conversation and the recipient's involvement. Here are several examples with use cases to illustrate this concept:

### Example 1: One-on-One Conversation

### Original Conversation:

User A: “I think we meet at 3 PM.”
User B: “You suggested 4 PM earlier.”

### Screenshot Sent to User A:

Annotated Screenshot:
User A: “You think we meet at 3 PM.”
User B: “I suggested 4 PM earlier.”

Explanation: When User A receives the screenshot, the pronouns are reversed to reflect User A's perspective. “I” becomes “You” and “You” becomes “I,” making the perspective clear who made each statement. This removes any ambiguity about who suggested the meeting times.

### Example 2: Group Conversation

### Original Conversation:

User A: “I will bring the snacks.”
User B: “You can bring the drinks.”
User C: “I will handle the decorations.”

### Screenshot Sent to User B:

Annotated Screenshot:
User A: “You will bring the snacks.”
User B: “I can bring the drinks.”
User C: “You will handle the decorations.”

Explanation: In a group conversation, reversing the pronouns ensures that each participant's statements are clear from the recipient's perspective. When User B receives the screenshot, the pronouns are adjusted so that User B can easily understand their role and the roles of others in the conversation.

### Example 3: Clarifying Misunderstandings

### Original Conversation:

User A: “You said you would finish the report by Friday.”
User B: “I did not say that.”

### Screenshot Sent to User B:

Annotated Screenshot:
User A: “I said you would finish the report by Friday.”
User B: “You said that.”

Explanation: Reversing the pronouns helps clarify misunderstandings by accurately representing the statements from the recipient's perspective. When User B receives the screenshot, the pronouns are reversed to show that User A claimed User B would finish the report, and User B denied making that statement.

### Example 4: Seeking Advice

### Original Conversation:

User A: “I am not sure about this decision.”
User B: “You go ahead with the task.”

### Screenshot Sent to a Third Party (User C):

Annotated Screenshot:
User A: “User A is not sure about this decision.”
User B: “User B go ahead with the task.”

Explanation: When sharing a screenshot with a third party, reversing the pronouns and replacing them with names ensures that the third party can clearly understand who made each statement. This removes any ambiguity and helps the third party provide informed advice.

### Example 5: Professional Context

### Original Conversation:

Manager: “I need you to complete the project by Monday.”
Employee: “I will do my utmost.”

### Screenshot Sent to the Employee:

Annotated Screenshot:
Manager: “You need to complete the project by Monday.”
Employee: “You will do your utmost.”

Explanation: In a professional context, reversing the pronouns ensures that the instructions and responses are clear from the recipient's perspective. When the employee receives the screenshot, the pronouns are adjusted to reflect the manager's instructions and the employee's response accurately. By reversing the pronouns, the system ensures that the annotated screenshot accurately represents the conversation from the recipient's perspective, reducing ambiguity and potential confusion. This process enhances the clarity and comprehensibility of shared screenshots, improving communication and reducing the likelihood of misunderstandings

In other embodiments, the modification and/or annotation at step 207 comprises reversing 402 a geometric alignment of communication instances of the communication dialogue depicted in the screenshot. In one or more embodiments, the reversing 42 occurs only when the remote electronic device belongs to an individual involved in the communication dialogue.

Reversing the geometric alignment of communication instances in a screenshot involves changing the visual layout of the messages to match the typical view of the recipient's messaging application. This process helps to remove ambiguity by ensuring that the recipient sees the messages in a familiar format, making the messages easier to understand. Here are several examples with use cases to illustrate this concept:

### Example 1: One-on-One Conversation

### Original Conversation:

User A: “I think we meet at 3 PM.”
User B: “You suggested 4 PM earlier.”

### Screenshot Sent to User A:

### Original Layout:

User A: “I think we meet at 3 PM.”
User B: “You suggested 4 PM earlier.”

### Reversed Layout:

User B: “You suggested 4 PM earlier.”
User A: “I think we meet at 3 PM.”

Explanation: When User A receives the screenshot, the messages are aligned to match User A's typical view, where User A's sent messages appear on the right and received messages on the left. This familiar layout helps User A quickly understand the conversation flow without confusion.

### Example 2: Group Conversation

### Original Conversation:

User A: “I will bring the snacks.”
User B: “You can bring the drinks.”
User C: “I will handle the decorations.”

### Screenshot Sent to User B:

### Original Layout:

User A: “I will bring the snacks.”
User B: “You can bring the drinks.”
User C: “I will handle the decorations.”
Reversed Layout:
User C: “I will handle the decorations.”
User B: “You can bring the drinks.”
User A: “I will bring the snacks.”

Explanation: In a group conversation, reversing the geometric alignment ensures that User B sees the messages in the same order and layout as they would appear in User B's messaging application. This consistency helps User B easily follow the conversation and understand each participant's contributions.

### Example 3: Clarifying Misunderstandings

### Original Conversation:

User A: “You said you would finish the report by Friday.”
User B: “I did not say that.”

### Screenshot Sent to User B:

### Original Layout:

User A: “You said you would finish the report by Friday.”
User B: “I did not say that.”

### Reversed Layout:

User B: “I did not say that.”
User A: “You said you would finish the report by Friday.”

Explanation: Reversing the geometric alignment helps clarify misunderstandings by presenting the conversation in a layout that User B is accustomed to. This familiar format makes the identification of the speaker of each statement easier for User B and aids in understanding the context of the conversation.

### Example 4: Seeking Advice

### Original Conversation:

User A: “I am not sure about this decision.”
User B: “You go ahead with the task. “Screenshot Sent to a Third Party (User C):

### Original Layout:

User A: “I am not sure about this decision.”
User B: “You go ahead with the task.”

### Reversed Layout:

User B: “You go ahead with the task.”
User A: “I am not sure about this decision.” Explanation: When sharing a screenshot with a third party, reversing the geometric alignment ensures that the third party sees the messages in a layout that matches their typical view. This consistency helps the third party quickly understand who made each statement and provide informed advice.

### Example 5: Professional Context

### Original Conversation:

Manager: “I need you to complete the project by Monday.”
Employee: “I will do my utmost.”

### Screenshot Sent to the Employee:

### Original Layout:

Manager: “I need you to complete the project by Monday.”
Employee: “I will do my utmost.”

### Reversed Layout:

Employee: “I will do my utmost.”
Manager: “I need you to complete the project by Monday.”

Explanation: In a professional context, reversing the geometric alignment ensures that the instructions and responses are presented in a layout that the employee is familiar with. This familiar format helps the employee quickly understand the manager's instructions and their own response, reducing ambiguity and potential confusion. By reversing the geometric alignment of communication instances, the system ensures that the annotated screenshot accurately represents the conversation in a layout that the recipient is accustomed to. This process enhances the clarity and comprehensibility of shared screenshots, improving communication and reducing the likelihood of misunderstandings.

In one or more embodiments, the annotating occurring at step 207 comprises changing a color of communication instances of the communication dialogue depicted in the screenshot.

Changing the color of communication instances of the communication dialogue depicted in the screenshot at step 207 of FIG. 4 helps remove ambiguity by visually distinguishing between different participants in the conversation. This method enhances clarity and makes the identification of the speaker easier for the recipient. Here are several examples with use cases to illustrate this concept:

### Example 1: One-on-One Conversation

### Original Conversation:

User A: “I think we meet at 3 PM.”
User B: “You suggested 4 PM earlier.”

### Screenshot Sent to User C:

### Original Layout:

User A: “I think we meet at 3 PM.”
User B: “You suggested 4 PM earlier.”
   Annotated Screenshot with Color Changes:
User A (in blue): “I think we meet at 3 PM.”
User B (in green): “You suggested 4 PM earlier.”

Explanation: By assigning different colors to User A and User B, the recipient (User C) can easily distinguish between the two participants. This visual differentiation helps User C quickly understand who made each statement, reducing the likelihood of confusion.

### Example 2: Group Conversation

### Original Conversation:

User A: “I will bring the snacks.”
User B: “You can bring the drinks.”
User C: “I will handle the decorations.”

### Screenshot Sent to User D:

### Original Layout:

User A: “I will bring the snacks.”
User B: “You can bring the drinks.”
User C: “I will handle the decorations.”
   Annotated Screenshot with Color Changes:
User A (in blue): “I will bring the snacks.”
User B (in green): “You can bring the drinks.”
User C (in red): “I will handle the decorations.”

Explanation: In a group conversation, using different colors for each participant helps the recipient (User D) easily identify the contributions of each participant. This visual aid ensures that User D can follow the conversation flow and understand each participant's role without confusion.

### Example 3: Clarifying Misunderstandings

### Original Conversation:

User A: “You said you would finish the report by Friday.”
User B: “I did not say that.”

### Screenshot Sent to User C:

### Original Layout:

User A: “You said you would finish the report by Friday.”
User B: “I did not say that.”
   Annotated Screenshot with Color Changes:
User A (in blue): “You said you would finish the report by Friday.”
User B (in green): “I did not say that.”

Explanation: When clarifying misunderstandings, color-coding the participants'statements helps the recipient (User C) quickly identify who made each statement. This visual distinction aids in understanding the context and resolving the misunderstanding more effectively.

### Example 4: Seeking Advice

### Original Conversation:

User A: “I am not sure about this decision.”
User B: “You go ahead with the task.”

### Screenshot Sent to a Third Party (User C):

### Original Layout:

User A: “I am not sure about this decision.”
User B: “You go ahead with the task.”
   Annotated Screenshot with Color Changes:
User A (in blue): “I am not sure about this decision.”
User B (in green): “You go ahead with the task.”
Explanation: When seeking advice from a third party, color-coding the participants'statements ensures that the third party (User C) can clearly understand who made each statement. This visual aid helps User C provide informed advice based on a clear understanding of the conversation.

### Example 5: Professional Context

### Original Conversation:

Manager: “I need you to complete the project by Monday.”
Employee: “I will do my utmost.”

### Screenshot Sent to the Employee:

### Original Layout:

Manager: “I need you to complete the project by Monday.”
Employee: “I will do my utmost.”
   Annotated Screenshot with Color Changes:
Manager (in blue): “I need you to complete the project by Monday.”
Employee (in green): “I will do my utmost.”
Explanation: In a professional context, color-coding the participants'statements ensures that the instructions and responses are clear. When the employee receives the screenshot, the color distinction helps them quickly understand the manager's instructions and their own response, reducing ambiguity and potential confusion. By changing the color of communication instances, the system ensures that the annotated screenshot accurately represents the conversation with clear visual cues. This process enhances the clarity and comprehensibility of shared screenshots, improving communication and reducing the likelihood of misunderstandings.

In one or more embodiments, the annotating of step 207 comprises overlays 404 presented on the screenshot with the overlays identifying the parties represented by the pronouns in the communication dialogue. In one or more embodiments (one example of which is shown in FIG. 2) the overlays partially overlap the pronouns in the communication dialogue on a one-to-one basis.

Placing overlays identifying the parties represented in the communication instances of the communication dialogue depicted in the screenshot at step 207 of FIG. 4, optionally with those overlays partially overlapping the pronouns in the communication dialogue on a one-to-one basis, removes ambiguity by clearly indicating who is speaking in each part of the conversation. This method ensures that the recipient of the annotated screenshot can easily understand the roles and identities of the participants, reducing the likelihood of misunderstandings. Here are several examples with use cases to illustrate this concept:
Example 1: One-on-One Conversation

### Original Conversation:

User A: “I think we meet at 3 PM.”
User B: “You suggested 4 PM earlier.”

### Screenshot Sent to User C:

### Original Layout:

User A: “I think we meet at 3 PM.”
User B: “You suggested 4 PM earlier.”
   Annotated Screenshot with Overlays:
User A: “I think we meet at 3 PM.” (Overlay: User A)
User B: “You suggested 4 PM earlier.” (Overlay: User B)

Explanation: By placing overlays with the names “User A” and “User B” over the pronouns “I” and “You,” the recipient (User C) can clearly see who made each statement. This removes any ambiguity about who suggested the meeting times.

### Example 2: Group Conversation

### Original Conversation:

User A: “I will bring the snacks.”
User B: “You can bring the drinks.”
User C: “I will handle the decorations.”

### Screenshot Sent to User D:

### Original Layout:

User A: “I will bring the snacks.”
User B: “You can bring the drinks.”
User C: “I will handle the decorations.”
   Annotated Screenshot with Overlays:
User A: “I will bring the snacks.” (Overlay: User A)
User B: “You can bring the drinks.” (Overlay: User B)
User C: “I will handle the decorations.” (Overlay: User C)

Explanation: In a group conversation, using overlays with the names of each participant helps the recipient (User D) easily identify who is responsible for each task. This visual aid ensures that User D can follow the conversation flow and understand each participant's role without confusion.

### Example 3: Clarifying Misunderstandings

### Original Conversation:

User A: “You said you would finish the report by Friday.”
User B: “I did not say that.”

### Screenshot Sent to User C:

### Original Layout:

User A: “You said you would finish the report by Friday.”
User B: “I did not say that.”
   Annotated Screenshot with Overlays:
User A: “You said you would finish the report by Friday.” (Overlay: User A)
User B: “I did not say that.” (Overlay: User B) Explanation: When clarifying misunderstandings, overlays with the names of the participants help the recipient (User C) quickly identify who made each statement. This visual distinction aids in understanding the context and resolving the misunderstanding more effectively.

### Example 4: Seeking Advice

### Original Conversation:

User A: “I am not sure about this decision.”
User B: “You go ahead with the task.”

### Screenshot Sent to a Third Party (User C):

### Original Layout:

User A: “I am not sure about this decision.”
User B: “You go ahead with the task.”
   Annotated Screenshot with Overlays:
User A: “I am not sure about this decision.” (Overlay: User A)
User B: “You go ahead with the task.” (Overlay: User B)
Explanation: When seeking advice from a third party, overlays with the names of the participants ensure that the third party (User C) can clearly understand who made each statement.
This visual aid helps User C provide informed advice based on a clear understanding of the conversation.

### Example 5: Professional Context

### Original Conversation:

Manager: “I need you to complete the project by Monday.”
Employee: “I will do my utmost.”

### Screenshot Sent to the Employee:

### Original Layout:

Manager: “I need you to complete the project by Monday.”
Employee: “I will do my utmost.”
   Annotated Screenshot with Overlays:
Manager: “I need you to complete the project by Monday.” (Overlay: Manager)
Employee: “I will do my utmost.” (Overlay: Employee)
Explanation: In a professional context, overlays with the names of the participants ensure that the instructions and responses are clear. When the employee receives the screenshot, the overlay distinction helps them quickly understand the manager's instructions and their own response, reducing ambiguity and potential confusion. By placing overlays identifying the parties represented in the communication instances, the system ensures that the annotated screenshot accurately represents the conversation with clear visual cues. This process enhances the clarity and comprehensibility of shared screenshots, improving communication and reducing the likelihood of misunderstandings.

In still other embodiments, the annotating of step 207 comprises replacing the pronouns in the communication dialogue with names 405 identifying the parties represented by the pronouns in the communication dialogue.

Replacing the pronouns in communication instances of the communication dialogue depicted in the screenshot at step 207 of FIG. 4 with names 405 identifying the parties removes ambiguity by clearly indicating who is speaking in each part of the conversation. This method ensures that the recipient of the annotated screenshot can easily understand the roles and identities of the participants, reducing the likelihood of misunderstandings. Here are several examples with use cases to illustrate this concept:

### Example 1: One-on-One Conversation

### Original Conversation:

User A: “I think we meet at 3 PM.”
User B: “You suggested 4 PM earlier.”

### Screenshot Sent to User C:

### Original Layout:

User A: “I think we meet at 3 PM.”
User B: “You suggested 4 PM earlier.”
   Annotated Screenshot with Names:
User A: “User A thinks we meet at 3 PM.”
User B: “User B suggested 4 PM earlier.”

Explanation: By replacing the pronouns “I” and “You” with “User A” and “User B,” the recipient (User C) can clearly see who made each statement. This removes any ambiguity about who suggested the meeting times.

### Example 2: Group Conversation

### Original Conversation:

User A: “I will bring the snacks.”
User B: “You can bring the drinks.”
User C: “I will handle the decorations.”

### Screenshot Sent to User D:

### Original Layout:

User A: “I will bring the snacks.”
User B: “You can bring the drinks.”
User C: “I will handle the decorations.”
   Annotated Screenshot with Names:
User A: “User A will bring the snacks.”
User B: “User B can bring the drinks.”
User C: “User C will handle the decorations.”

Explanation: In a group conversation, using names for each participant helps the recipient (User D) easily identify who is responsible for each task. This visual aid ensures that User D can follow the conversation flow and understand each participant's role without confusion.

### Example 3: Clarifying Misunderstandings

### Original Conversation:

User A: “You said you would finish the report by Friday.”
User B: “I did not say that.”

### Screenshot Sent to User C:

### Original Layout:

User A: “You said you would finish the report by Friday.”
User B: “I did not say that.”
   Annotated Screenshot with Names:
User A: “User A said User B would finish the report by Friday.”
User B: “User B did not say that.”

Explanation: When clarifying misunderstandings, replacing the pronouns with names helps the recipient (User C) quickly identify who made each statement. This visual distinction aids in understanding the context and resolving the misunderstanding more effectively.

### Example 4: Seeking Advice

### Original Conversation:

User A: “I am not sure about this decision.”
User B: “You go ahead with the task.”

### Screenshot Sent to a Third Party (User C):

### Original Layout:

User A: “I am not sure about this decision.”
User B: “You go ahead with the task.”
   Annotated Screenshot with Names:
User A: “User A is not sure about this decision.”
User B: “User B go ahead with the task.”
Explanation: When seeking advice from a third party, replacing the pronouns with names ensures that the third party (User C) can clearly understand who made each statement. This visual aid helps User C provide informed advice based on a clear understanding of the conversation.

### Example 5: Professional Context

### Original Conversation:

Manager: “I need you to complete the project by Monday.”
Employee: “I will do my utmost.”

### Screenshot Sent to the Employee:

### Original Layout:

Manager: “I need you to complete the project by Monday.”
Employee: “I will do my utmost.”
   Annotated Screenshot with Names:
Manager: “Manager needs Employee to complete the project by Monday.”
Employee: “Employee will do their utmost.”

Explanation: In a professional context, replacing the pronouns with names ensures that the instructions and responses are clear. When the employee receives the screenshot, the name distinction helps them quickly understand the manager's instructions and their own response, reducing ambiguity and potential confusion. By replacing the pronouns with names, the system ensures that the annotated screenshot accurately represents the conversation with clear visual cues. This process enhances the clarity and comprehensibility of shared screenshots, improving communication and reducing the likelihood of misunderstandings.

In some embodiments where pronouns are replaced with names, the text 406 can be modified to indicate that a modification has been made. Illustrating by example, the text 406 may be boldfaced, underlined, or turned italics to indicate modification.

In one or more embodiments, the system modifies a screenshot by replacing pronouns with names to clearly indicate the identities of the participants in the communication dialogue. This modification can be achieved through various methods to ensure that the recipient of the screenshot understands that the screenshot has been altered for clarity.

One approach involves boldfacing the text where pronouns have been replaced with names. By making the modified text bold, the system visually distinguishes the changes, drawing the recipient's attention to the specific areas that have been altered. This method ensures that the recipient is aware of the modifications while maintaining the readability of the conversation.

Another method involves underlining the modified text. Underlining the names that replace pronouns provides a clear visual cue that these parts of the text have been altered. This approach helps the recipient quickly identify the modifications without disrupting the overall flow of the conversation.

Additionally, the system can use italics to indicate the modified text. Italicizing the names that replace pronouns subtly highlights the changes, ensuring that the recipient notices the modifications while preserving the natural appearance of the conversation. In some embodiments, the system may combine these methods to enhance the clarity of the modifications. For example, the system can use a combination of bold and italics to emphasize the replaced names further.

This dual emphasis ensures that the recipient is fully aware of the modifications, reducing the likelihood of misunderstandings. By employing these various methods to modify a screenshot when replacing pronouns with names, the system ensures that the recipient can easily understand the identities of the participants in the communication dialogue while being clearly informed that the screenshot has been altered for clarity.

In one or more embodiments, step 207 further comprising determining, by the one or more processors, whether the remote electronic device belongs to a participant of the communication dialogue and whether the communication dialogue is a one-to-one conversation. In one or more embodiments, when the remote electronic device belongs to the participant of the communication dialogue and the communication dialogue is the one-to-one conversation the annotating comprises replacing first person pronouns 408 with second person pronouns and vice versa

Where optional step (203) is included in the method (200) of FIG. 2, step 207 can ensure that the names of third parties 407, i.e., those not engaged in the original conversation, are identified in the screenshot. In one or more embodiments, step (203) of the method (200) of FIG. 2 comprises determining, by the one or more processors, whether the remote electronic device to which the screenshot will be sent belongs to a third party who was uninvolved in the communication dialogue. In one or more embodiments, the annotating of step 207 occurs only when the third party was uninvolved with the communication dialogue. In other embodiments, the annotating of step 207 occurs only when the communication dialogue is a group conversation.

The identities of parties privy to the initial conversation can be replaced with names as well. When there is personal information, it can be obscured 409 to protect the innocent. Thus, in one or more embodiments step 207 comprises obscuring 409, by the one or more processors prior to the communication device transmitting the screenshot, private information of original participants of the communication dialogue depicted in the screenshot

Turning now back to FIG. 2, at step 208 the method 200 comprises causing, by the one or more processors, a communication device to transmit the annotated screenshot 211 to a remote electronic device across a network. As shown at step 208, the annotations of this example use overlays 210 presented on the annotate screenshot 211. In this example, the overlays. 210 identify the parties represented by the pronouns in the communication dialogue and partially overlap the pronouns in the communication dialogue on a one-to-one basis.

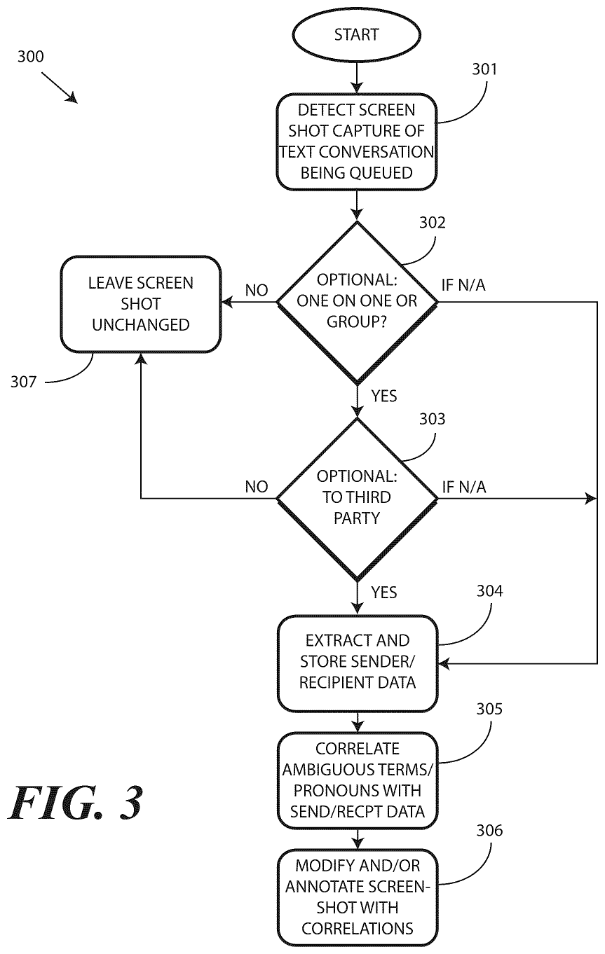

Turning now to FIG. 3, illustrated therein is another explanatory method 300 in accordance with one or more embodiments of the disclosure. In one or more embodiments, method 300 begins at step 301 by detecting the capture of a screenshot of a text conversation being queued. In one or more embodiments, this detection occurs when the user initiates a screenshot capture action on the electronic device. The one or more processors can monitor the user interface for specific input signals that indicate a screenshot capture request. These signals can include a combination of button presses, touch gestures, or voice commands. Once the system detects the screenshot capture at step 301, the method moves to decision 302.

After detecting the screenshot capture, the system optionally determines at decision 302 whether the communication dialogue belongs to a one-on-one conversation or a group conversation. This determination involves, in one or more embodiments, analyzing the metadata associated with the text conversation, such as the number of participants and the structure of the dialogue. The processors can access the contact database to identify the participants involved in the conversation.

If the screenshot contains no conversation dialogue, it remains unchanged at step 307. If there is a one-on-one conversation or group conversation depicted, the method 300 moves to decision 303. If decision 302 is omitted, the method 300 moves to step 304.

In optional decision 303, the method determines whether the screenshot is being shared with a third party who was not part of the original communication dialogue. In one or more embodiments this determination involves analyzing the recipient information associated with the screenshot sharing action. The processors can compare the recipient's contact details with the participants of the original conversation. If the recipient is identified as a third party, the method 300 may apply additional modifications to the screenshot to ensure that the third party can clearly understand the context and participants of the conversation. In one or more embodiments, the annotating of step 306 occurs only when the third party was uninvolved with the communication dialogue.

Step 304 extracts and stores the sender and recipient data from the text conversation depicted in the screenshot. This extraction process involves using natural language processing (NLP) algorithms and machine learning models to analyze the text and identify the participants. The processors can access the contact database to retrieve the relevant contact details for each participant. The extracted data can be then stored as metadata associated with the screenshot. This metadata includes information such as the names, contact details, and roles of the participants in the conversation.

At step 305, the method 300 correlates any ambiguous terms or pronouns in the text conversation with the sender and recipient data extracted in the previous step. The processors can use NLP algorithms to analyze the context of the conversation and determine the referents of ambiguous terms and pronouns. By examining the surrounding text and the structure of the dialogue, the system can accurately map pronouns such as “I” and “you” to specific participants. This correlation process ensures that the roles and identities of the participants are clearly understood, reducing ambiguity and potential confusion.

At step 306, the method 300 modifies and/or annotates the screenshot with the correlations identified in the previous step. This modification process can involve several techniques to enhance the clarity of the conversation for the recipient.

Illustrating by example, the processors may apply overlays to the screenshot, identifying the parties represented by the pronouns in the conversation. These overlays can partially overlap the pronouns on a one-to-one basis. Alternatively, the system may replace the pronouns with the actual names of the participants. The modifications can also include reversing the geometric alignment of the messages, changing the color of the text, or adding annotations to indicate that modifications have been made. These modifications ensure that the recipient can easily understand the roles and identities of the participants in the conversation.

In some cases, the system may determine that no modifications are necessary, and the screenshot can be left unchanged at step 307. This step 307 is based on the analysis of the conversation context and the recipient information. If the system determines that the recipient is already familiar with the participants and context of the conversation, or if the conversation is straightforward and unambiguous, the processors may choose to leave the screenshot as is. This step 307 ensures that the system only applies modifications when necessary, preserving the original content of the conversation when appropriate.

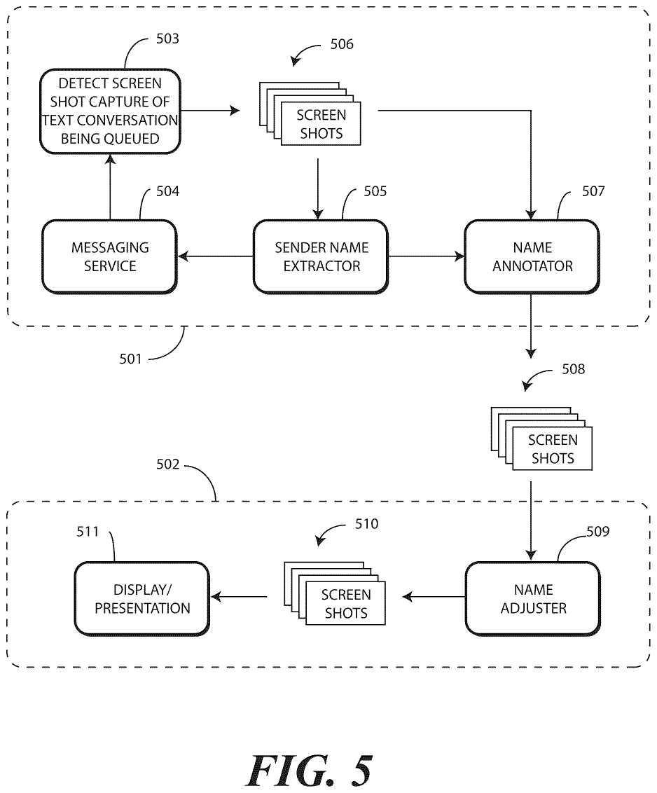

Turning now to FIG. 5, illustrated therein ins one explanatory system in accordance with one or more embodiments of the disclosure. FIG. 5 shows a system for detecting the capture of a screenshot depicting communication dialogue, extracting identifiers of persons represented by at least some words depicted in the communication dialogue, annotating the at least some words with the identifiers of the persons to create an annotated screenshot, and causing a communication device to transmit the annotated screenshot to a remote electronic device across a network.

The system 501 initiates with the detection of a screenshot capture of a text conversation being queued 503. This detection triggers the process of handling the screenshot. The detected screenshot 506 is then processed by the messaging service 504, which interfaces with the messaging application to extract relevant data from the screenshot.

The sender name extractor 505 receives the screenshot from the messaging service 504. The sender name extractor 505 utilizes optical character recognition (OCR) and artificial intelligence (AI) techniques to identify and extract the names of the senders of the messages depicted in the screenshot. This extracted information is for the subsequent annotation process.

The name annotator 507 receives the extracted sender information from the sender name extractor 505. The name annotator 507 then annotates the screenshot with the extracted sender names, ensuring that each message in the screenshot is clearly labeled with the corresponding sender's name.

This annotated screenshot 508 is then prepared for further processing. The system 502 includes the name adjuster 509, which receives the annotated screenshot 508. The name adjuster 509 adjusts the names in the screenshot based on the recipient's contact database. This adjustment ensures that the names are presented in a manner that is familiar and understandable to the recipient.

The adjusted screenshot 510 is then ready for display or presentation. The display/presentation component 511 receives the adjusted screenshot 510 from the name adjuster 509. The display/presentation component 511 presents the final annotated and adjusted screenshot to the recipient, ensuring that the communication dialogue is clear and comprehensible. This system effectively addresses the problem of ambiguity in shared screenshots by providing clear identification of the participants in the communication dialogue, thereby enhancing the clarity and reducing the likelihood of misunderstandings. §

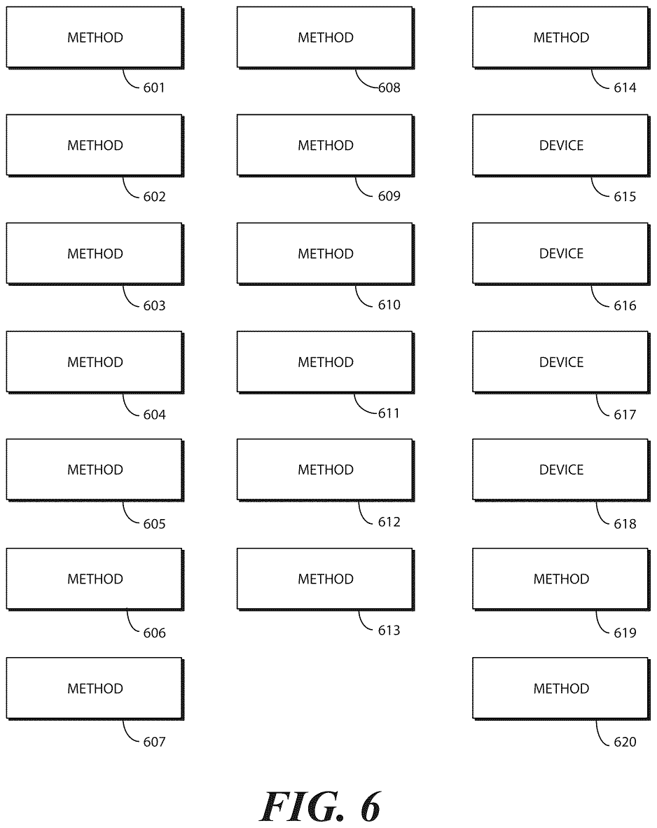

Turning now to FIG. 6, illustrated therein are various embodiments of the disclosure. The embodiments of FIG. 6 are shown as labeled boxes in FIG. 6 due to the fact that the individual components of these embodiments have been illustrated in detail in FIGS. 1-5, which precede FIG. 6. Accordingly, since these items have previously been illustrated and described, their repeated illustration is no longer essential for a proper understanding of these embodiments. Thus, the embodiments are shown as labeled boxes.

At 601, a method in an electronic device comprises receiving, at a user interface, user input requesting a communication device of the electronic device transmit a screenshot of communication dialogue to a remote electronic device. At 601, the method comprises extracting, by one or more processors, from application data of an application from which the screenshot was taken, identifiers of parties represented by pronouns in the communication dialogue. At 601, the method comprises modifying, by the one or more processors prior to transmission by the communication device, the screenshot so that the pronouns in the communication dialogue identify the parties represented by the pronouns in the communication dialogue.

At 602, the extracting of 601 is performed using artificial intelligence (AI) processing. AT 603, the method of 601 further comprises determining, by the one or more processors, whether the communication dialogue is a one-to-one conversation or a group conversation. At 605, the annotating of 604 occurs only when the communication dialogue is a group conversation.

At 605, the method of 601 further comprises determining, by the one or more processors, whether the remote electronic device belongs to a third party who was uninvolved in the communication dialogue. At 606, the annotating of 605 occurs only when the third party was uninvolved with the communication dialogue.

At 607, the annotating of 601 comprises overlays presented on the screenshot with the overlays identifying the parties represented by the pronouns in the communication dialogue. At 608 the overlays of 607 partially overlap the pronouns in the communication dialogue on a one-to-one basis.

At 609, the annotating of 601 comprises replacing the pronouns in the communication dialogue with names identifying the parties represented by the pronouns in the communication dialogue. At 610, the annotating of 601 comprises reversing a geometric alignment of communication instances of the communication dialogue depicted in the screenshot. At 611, the reversing of 610 occurs only when the remote electronic device belongs to an individual involved in the communication dialogue.

At 612, the annotating of 601 comprises changing a color of communication instances of the communication dialogue depicted in the screenshot. At 613, the annotating of 601 comprises reversing the pronouns in the communication dialogue. At 614, the method of 601 further comprises obscuring, by the one or more processors prior to the communication device transmitting the screenshot, private information of original participants of the communication dialogue depicted in the screenshot.

At 615, an electronic device comprises a user interface, a communication device, and one or more processors operable with the user interface and the communication device. At 615, the one or more processors are configured to, in response to the user interface receiving user input capturing a screenshot of a communication dialogue, identify parties engaged in the communication dialogue represented by pronouns in the communication dialogue from a contact database accessible to the one or more processors, and modify the screenshot to cause the parties identified by the pronouns to be identified by name.

At 616, the one or more processors of 615 are further configured to present a preview of the screenshot after modification prior to the communication device transmitting the screenshot. At 617, the one or more processors of 615 are further configured to log modifications to the screenshot and attach the log of modifications to the screenshot after modification as metadata. At 618, the modifications 615 of the screenshot are pursuant to modification instructions defined by a user in the electronic device, with those modification instructions comprising one of presenting overlays over the screenshot or changing text of the screenshot.

At 619, a method in an electronic device comprises detecting, by one or more processors, capture of a screenshot depicting communication dialogue. At 619, the method comprises extracting, by the one or more processors, identifiers of persons represented by at least some words depicted in the communication dialogue.

At 619, the method comprises annotating, by the one or more processors, the at least some words with the identifiers of the persons to create an annotated screenshot. At 619, the method comprises causing, by the one or more processors, a communication device to transmit the annotated screenshot to a remote electronic device across a network.

At 620, the method of 619 further comprises determining, by the one or more processors, whether the remote electronic device belongs to a participant of the communication dialogue and whether the communication dialogue is a one-to-one conversation. At 620, when the remote electronic device belongs to the participant of the communication dialogue and the communication dialogue is the one-to-one conversation, the annotating comprises replacing first person pronouns with second person pronouns and vice versa.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, at a user interface, user input requesting a communication device of the electronic device transmit a screenshot of communication dialogue to a remote electronic device;
extracting, by one or more processors, from application data of an application from which the screenshot was taken, identifiers of parties represented by pronouns in the communication dialogue; and
modifying, by the one or more processors prior to transmission by the communication device, the screenshot so that the pronouns in the communication dialogue identify the parties represented by the pronouns in the communication dialogue.

2. The method of claim 1, wherein the extracting is performed using artificial intelligence (AI) processing.

3. The method of claim 1, further comprising determining, by the one or more processors, whether the communication dialogue is a one-to-one conversation or a group conversation.

4. The method of claim 3, wherein the annotating occurs only when the communication dialogue is a group conversation.

5. The method of claim 1, further comprising determining, by the one or more processors, whether the remote electronic device belongs to a third party who was uninvolved in the communication dialogue.

6. The method of claim 5, wherein the annotating occurs only when the third party was uninvolved with the communication dialogue.

7. The method of claim 1, wherein the annotating comprises overlays presented on the screenshot with the overlays identifying the parties represented by the pronouns in the communication dialogue.

8. The method of claim 7, wherein the overlays partially overlap the pronouns in the communication dialogue on a one-to-one basis.

9. The method of claim 1, wherein the annotating comprises replacing the pronouns in the communication dialogue with names identifying the parties represented by the pronouns in the communication dialogue.

10. The method of claim 1, wherein the annotating comprises reversing a geometric alignment of communication instances of the communication dialogue depicted in the screenshot.

11. The method of claim 10, wherein the reversing occurs only when the remote electronic device belongs to an individual involved in the communication dialogue.

12. The method of claim 1, wherein the annotating comprises changing a color of communication instances of the communication dialogue depicted in the screenshot.

13. The method of claim 1, wherein the annotating comprises reversing the pronouns in the communication dialogue.

14. The method of claim 1, further comprising obscuring, by the one or more processors prior to the communication device transmitting the screenshot, private information of original participants of the communication dialogue depicted in the screenshot.

15. An electronic device, comprising:
a user interface;
a communication device; and
one or more processors operable with the user interface and the communication device;
wherein the one or more processors are configured to, in response to the user interface receiving user input capturing a screenshot of a communication dialogue, identify parties engaged in the communication dialogue represented by pronouns in the communication dialogue from a contact database accessible to the one or more processors, and modify the screenshot to cause the parties identified by the pronouns to be identified by name.

16. The electronic device of claim 15, wherein the one or more processors are further configured to present a preview of the screenshot after modification prior to the communication device transmitting the screenshot.

17. The electronic device of claim 15, wherein the one or more processors are further configured to log modifications to the screenshot and attach the log of modifications to the screenshot after modification as metadata.

18. The electronic device of claim 15, wherein modifications of the screenshot are pursuant to modification instructions defined by a user in the electronic device, with those modification instructions comprising one of presenting overlays over the screenshot or changing text of the screenshot.

19. A method in an electronic device, the method comprising:
detecting, by one or more processors, capture of a screenshot depicting communication dialogue;
extracting, by the one or more processors, identifiers of persons represented by at least some words depicted in the communication dialogue;
annotating, by the one or more processors, the at least some words with the identifiers of the persons to create an annotated screenshot; and
causing, by the one or more processors, a communication device to transmit the annotated screenshot to a remote electronic device across a network.

20. The method of claim 19, further comprising determining, by the one or more processors, whether the remote electronic device belongs to a participant of the communication dialogue and whether the communication dialogue is a one-to-one conversation, wherein when the remote electronic device belongs to the participant of the communication dialogue and the communication dialogue is the one-to-one conversation the annotating comprises replacing first person pronouns with second person pronouns and vice versa.
